(19) United States
(12) Patent Application Publication
(10) Pub. No.: US 2012/0179603 A1
(43) Pub. Date: Jul. 12, 2012

(54) PURCHASER-SPECIFIC CURRENCY CONVERSION

(75) Inventors: Brian Frey, Coral Springs, FL (US); Oghie Sheehy, Killarney (IE)

(73) Assignees: Fexco Merchant Services, Killorglin (IE); First Data Corporation, Greenwood Village, CO (US)

(21) Appl. No.: 13/004,595

(22) Filed: Jan. 11, 2011

(51) Int. Cl. G06Q 40/00

(52) U.S. Cl. 705/39

(57) ABSTRACT

Methods and systems for conducting online payments using a currency other than a base currency of a webpage are described. An indication of a purchaser's currency may be received. A plurality of prices on a webpage in a base currency may be identified. A request for a conversion rate between the base currency of the webpage and the purchaser's currency may be transmitted to a host computer system. The identified plurality of prices on the webpage listed in the base currency may be converted to a plurality of prices in the purchaser's currency using the conversion rate received from the host computer system. Purchase information and an identifier linked to the purchase information may be transmitted to a merchant computer system to conduct the online payment.

### BACKGROUND

E-commerce is a worldwide phenomenon. A purchaser may transact with a merchant located in some country other than where the purchaser is located. If the merchant is located in some other country, the merchant may conduct transactions in a currency other than the currency used by the purchaser. Having to conduct a transaction in a different currency may be inconvenient for the purchaser. For example, the purchaser may not know the currency conversion rate between the purchaser's currency and the currency used by the merchant. Also, when deciding whether to purchase goods and/or services from the merchant, the purchaser may need to manually (e.g., by hand, using a calculator, or in the consumer's mind) convert the merchant's price from the merchant's currency to a price in the purchaser's currency to determine if he wishes to purchase the goods and/or services.

### SUMMARY

In some embodiments, a method for conducting an online payment using a currency other than a base currency of a webpage is present. The method may include receiving, by a client computer system from a merchant computer system, the webpage. The method may include receiving, by the client computer system, an indication of a purchaser's currency. The method may also include identifying, by the client computer system, a plurality of prices on the webpage. The plurality of prices on the webpage may be in the base currency of the webpage. The base currency of the webpage may be different from the purchaser's currency. The method may include transmitting, by the client computer system to a host computer system, a request for a conversion rate between the base currency of the webpage and the purchaser's currency. The method may include receiving, by the client computer system from the host computer system, the conversion rate between the base currency and the purchaser's currency. The method may include converting, by the client computer system, the identified plurality of prices on the webpage listed in the base currency to a plurality of prices in the purchaser's currency using the conversion rate received from the host computer system. The method may include transmitting, by the client computer system to the host computer system, purchase information. The method may include receiving, by the client computer system from the host computer system, in response to the purchase information, a purchase identifier linked to the purchase information. Further, the method may include transmitting, by the client computer system to the merchant computer system, the purchase identifier linked to the purchase information.

In some embodiments, a method may further include transmitting, by the client computer system to the merchant computer system, payment information, wherein the payment information comprises an account number linked to the purchaser. The purchase information may comprise an indication of the purchaser and at least one product code. In some embodiments, a method may further include transmitting, by the merchant computer system to the host computer system, the purchase identifier. In some embodiments, a method may further include receiving, by the merchant computer system from the host computer system, at least a portion of the purchase information linked with the purchase identifier. In some embodiments, the purchase information linked with the purchase identifier comprises a price of an item to be purchased. Also, the price of the item to be purchased may be confirmed between the host computer system and the merchant computer system. The indication of the purchaser's currency may be received from an IP detection system. A method may also include authorizing, by the merchant computer system, the online payment in the purchaser's currency. In some embodiments, a method may further include settling the online payment in the purchaser's currency, wherein a value of the purchaser's currency used to settle the online payment for the at least one item is approximately equal to a value of the base currency to settle the online payment for the at least one item. The plurality of prices converted using the conversion rate may remain static for at least a period of time, wherein the period of time is selected from a group consisting of: an hour; a day; a week; a month; and a session between the client computer system and the merchant computer system. In some embodiments, the indication of a purchaser's currency is selected by the purchaser from a list of a plurality of currencies.

In some embodiments, a system for converting prices on a webpage to a currency other than a base currency of the webpage is presented. The system may include a computer system, comprising a memory, wherein the memory is configured to provide the computer system with instructions, which when executed, cause the computer system to: receive, from a client computer system, a request for a conversion rate between a base currency and a purchaser's currency. The plurality of prices on the webpage may be initially listed in the base currency; and the base currency and the purchaser's currency may be different currencies. The instructions may also include instructions, which when executed, cause the computer system to transmit, to the client computer system, the conversion rate between the base currency and the purchaser's currency; and receive, from the client computer system, purchase information. The purchase information may indicate that a purchaser intends to conduct a purchase through a merchant computer system using the conversion rate transmitted to the client computer system. The merchant computer system may be separate from the host computer system. The instructions may also include instructions, which when executed, cause the computer system to transmit, to the client computer system, in response to receiving the purchase information, a purchase identifier linked with the purchase information. The instructions may also include instructions, which when executed, cause the computer system to receive, from the merchant computer system, the purchase identifier; and to transmit, to the merchant computer system, at least some of the purchase information linked with the purchase identifier.

In some embodiments, a system for conducting an online purchase in a currency other than a base currency of a webpage is present. The system may include a computer system, comprising a memory, wherein the memory is configured to provide the computer system with instructions, which when executed, cause the computer system to: receive, from a host computer system, a plurality of conversion rates between the base currency of the webpage and a plurality of currencies, and transmit, to a client computer system, a webpage and a currency conversion plug-in. The currency conversion plug-in may be configured to convert prices displayed on the webpage from the base currency of the webpage to a currency of a purchaser. A merchant may operate the computer system. The purchaser may operate the client computer system. The plurality of currencies may comprise a currency of the purchaser. The instructions may further comprise instructions, that when executed, cause the processor to receive, from the client computer system, purchase information and payment information, wherein the payment information is used to conduct the payment in the purchaser's currency; and authorize the purchase in the purchaser's currency.

### BRIEF DESCRIPTION OF THE DRAWINGS

FIG. 1 illustrates a high level diagram of an embodiment of an inline currency conversion system.

FIG. 2A illustrates a high level diagram of another embodiment of an inline currency conversion system.

FIG. 2B illustrates a high level diagram of another embodiment of an inline currency conversion system.

FIG. 2C illustrates a high level diagram of another embodiment of an inline currency conversion system.

FIGS. 3A and 3B illustrate a swim diagram of a method for conducting an inline currency conversion.

FIGS. 4A and 4B illustrate a swim diagram of another method for conducting an inline currency conversion.

FIGS. 5A-5C illustrate a swim diagram of another method for conducting an inline currency conversion.

FIG. 6 illustrates a simplified block diagram of a computer system.

### DETAILED DESCRIPTION

For a purchaser conducting an online purchase transaction, that is, a person who desires to purchase a good and/or service online, it may be preferable to view prices and conduct the purchase using the purchaser's native currency. Having prices appear in the purchaser's currency may eliminate the need for the purchaser to determine the conversion rate between the currency used by the merchant (referred to as the merchant's base currency) and the purchaser's currency. Having prices presented to the purchaser in the purchaser's currency may eliminate the need for the purchaser to calculate prices in the purchaser's currency using the conversion rate and the prices in the base currency. Having prices appear in the purchaser's currency may also make it more immediately apparent to the purchaser as to whether the goods and/or services being viewed are a good deal. Further, decreasing the amount of work necessary for the purchaser to determine whether he wishes to conduct a purchase may make it more likely that the purchaser will indeed complete the purchase. Further, providing prices in the purchaser's currency may increase the likelihood that a purchaser will be willing to complete a purchase with a foreign merchant.

Consider the following example, provided for illustration purposes only: A purchaser in the United States, who typically makes purchases using the United States Dollar (USD) is shopping for a certain model of backpack. He has found a merchant (online or otherwise) within the United States who is selling the backpack for $227 USD. While shopping online, the purchaser located two foreign merchants selling the same model backpack. The first foreign merchant is located in Germany and sells backpacks in Euros. The price listed on the German merchant's website is 176 Euros. The second merchant is located in Japan. This Japanese merchant, which sells goods in Yen, is selling the same model backpack for 15,780 Yen. The purchaser may not know which price is best and may settle on the merchant in the United States so that he does not need to deal with a foreign currency. Alternatively, the customer may guess that the German merchant is the best deal (after all, the number 176 is less than 227). Or, in another scenario, the purchaser may look up the currency conversion (also referred to as exchange) rates and determine that the price offered by the German merchant is approximately equivalent to $241, while the price offered by the Japanese merchant is approximately equivalent to $189. After conducting the conversions, and perhaps conducting similar calculations for applicable taxes and shipping charges, the purchaser may elect to purchase the backpack from the Japanese merchant.

Rather than the purchaser manually converting prices, guessing, or avoiding foreign merchants, a merchant dealing with a purchaser who uses a different currency may offer the purchaser the opportunity to view prices and complete payment in the purchaser's currency. To do this, the merchant may partner with an entity that provides currency exchange rates. A purchaser may contact a website of the merchant and the merchant may respond by sending a webpage to the purchaser. A currency conversion plug-in, or other form of code, may be referenced by the webpage. This conversion plug-in, which may be acquired by the computer used by the purchaser, may allow the purchaser to specify his desired currency or, using a technique such as IP detection, may determine the region the purchaser is located in. Based on the region the purchaser is located in, the conversion plug-in may determine the purchaser's currency. The plug-in may then contact a host computer system, possibly operated by the entity providing the exchange rates or by the merchant, to receive the conversion rate between the purchaser's currency and the merchant's base currency. The plug-in may identify the prices on the webpage that appear in the base currency of the merchant. Using the received conversion rate, the plug-in may convert each price from the base currency of the merchant to an equivalent or approximately equivalent price in the purchaser's currency. This may allow the purchaser to view the merchant's prices in the purchaser's currency and complete payment in the purchaser's currency.

If and when the purchaser decides to make a purchase, purchase information may be sent to the host computer system by the purchaser's computer system. This purchase information, which may contain information such as the exchange rate used to convert between the purchaser's currency and the base currency, the price in the purchaser's currency, a product code for each item being purchased, a quantity of items being purchased, the price in the base currency, and/or information identifying the purchaser, may be stored by the host computer system. The host computer system may return a purchase identifier to the purchaser's computer system. This purchase identifier may be sent to the merchant computer system by the purchaser's computer system. The purchaser may then complete the purchase transaction with the merchant in the purchaser's currency.

The merchant's computer system may use the purchase identifier to confirm some or all of the purchase information with the host computer system. For example, the merchant may confirm the conversion rate used and the price in the purchaser's currency with the host computer system. The merchant may complete the transaction with the purchaser and authorize the payment in the purchaser's currency. The payment may be paid to the merchant in the purchaser's currency but, due to the conversion handled by the host computer system, the value of the amount in the purchaser's currency is expected to be equivalent or roughly equivalent to the value of the price in the base currency of the merchant.

Other embodiments are possible that alter the interactions between the purchaser's computer system and the host computer system, and the interactions between the merchant computer system and the host computer system. Such various embodiments, along with the above described embodiments, are described in detail below.

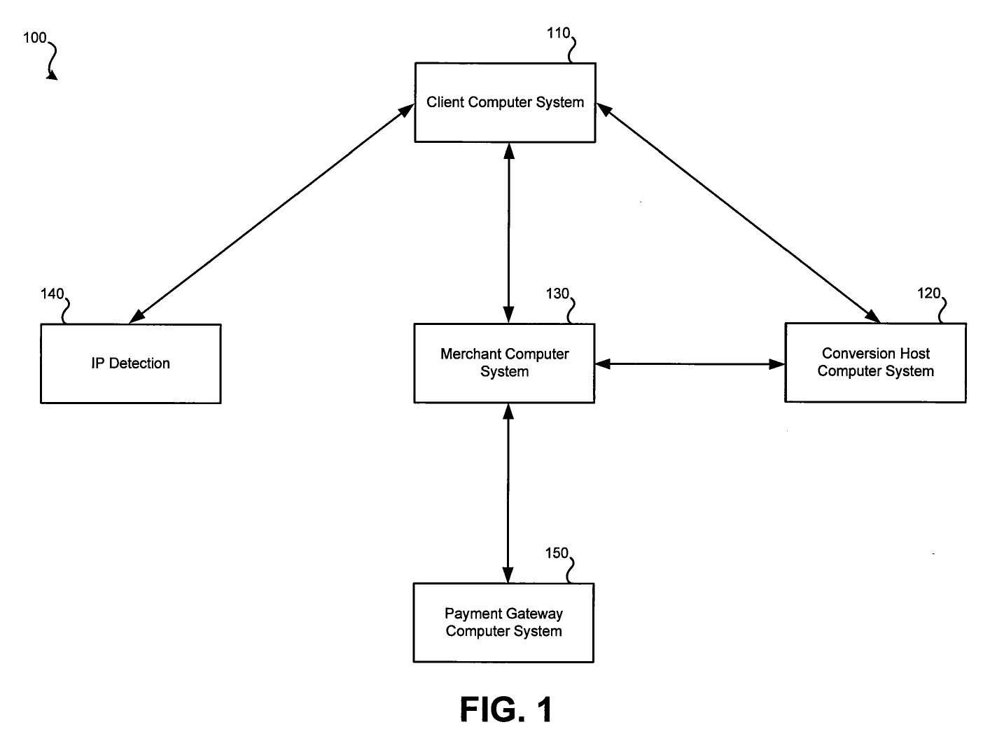

FIG. 1 illustrates a high level diagram of an embodiment of an inline currency conversion system 100. Inline currency conversion system 100 includes a client computer system 110, a merchant computer system 130, an IP (Internet Protocol) detection system 140, a payment gateway computer system 150, and a conversion host computer system 120.

Client computer system 110 may be a computer operated by a purchaser that desires to make one or more online purchases. Client computer system 110 may be a computer, such as a desktop computer, laptop computer, or tablet computer. Client computer system 110 may also be some other form of computerized device, such as a smart phone, kiosk, Internet-enabled television, or public kiosk. As those with skill in the art will recognize, other forms of client computer system 110 are possible that allow a purchaser to conduct purchases with a merchant.

Merchant computer system 130 may be a computer system that receives and responds to requests for one or more webpages maintained by the merchant. For example, merchant computer system 130 may be operated by the merchant or by some third party entity on behalf of the merchant. When a purchaser accesses one or more websites, the requests may be directed to merchant computer system 130.

Payment gateway computer system 150 may be used to authorize and settle payment transaction conducted between purchasers and merchants. Payment gateway computer system 150 may be operated by a third party entity separate from the merchant, a credit card processor, or by the merchant directly.

IP detection computer system 140 may be used to determine the currency likely used by the purchaser using client computer system 110. Based upon an IP address of the client computer system 110, IP Detection system 140 may determine the country where client computer system 110 is located. If the client computer system 110 retrieves a webpage from merchant computer system 130, the webpage may contain code, such as a plug-in, that accesses IP detection system 140. IP detection system 140 may identify the IP address of client computer system 110 and look up the country or currency associated the IP address or a range of IP addresses that includes the IP address. IP detection system 140 may send a response to client computer system 110 identifying a country or a currency. If IP detection system 140 responds with an indication of a country, client computer system 110 may identify a currency associated with the country. Instead of using IP detection computer system 140, a customer may, via preference setup, select a location preference. In some embodiments, a listing of different currencies may be presented to the customer, thus allowing the customer to select his preferable currency.

For illustration purposes only, consider the following example, a purchaser using client computer system 110 may retrieve a webpage from merchant computer system 130. The webpage may have a plug-in embedded (e.g., the plug-in is received directly from the merchant computer system or is downloaded from some other computer system). The plug-in may access IP detection system 140 and send the IP address of client computer system 110 to IP Detection system 140. As an example, this IP address may be 79.146.82.1. Based on the IP Address, IP detection system 140 may determine that client computer system 110 is located in Spain. IP detection system 140 may respond to client computer system 110 by identifying Spain as the country in which client computer system 110 is located. Based on the response of Spain, the plug-in may select the Euro as the currency of the purchaser using client computer system 110. Alternatively, instead of responding with an indication of Spain, IP Detection system 140 may indicate the Euro as the purchaser's currency, thus eliminating the need for the plug-in to determine the currency associated with Spain. IP detection system 140 may be a separate, third-party computer system or may be resident on the host computer system.

Conversion Host Computer System 120, also referred to as host computer system 120 for short, may perform several functions, such as: providing the plug-in to client computer systems, providing conversion rate information, receiving purchase information from client computer system 110, and/or exchanging purchase information with merchant computer system 130. Host computer system 120 may be operated by an entity distinct from merchant computer system 130.

In order for a merchant to allow a purchaser to conduct a purchase in the purchaser's currency, the merchant may need to add code to one or more of its webpages that interfaces with a plug-in supplied by host computer system 120. The merchant operating merchant computer system 130 may keep its prices in the base currency. To be clear, the base currency refers to the currency used by the merchant. For example, a merchant located in the United States would likely have the United States Dollar as its base currency. When a purchaser loads a webpage from merchant computer system 130, code or a plug-in included in, or referenced by, the webpage may contact host computer system 120 to download additional code or components of the plug-in.

Based upon the currency identified using IP detection system 140 or a selection made by the purchaser, client computer system 110 may request a conversion rate from host computer system 120. This conversion rate may be used by the plug-in stored by the client computer system 110 to convert the prices on the webpage from the base currency to the purchaser's currency.

Once a purchaser has selected one or more goods and/or services (collectively referred to as items) for purchase, an indication may be sent to the host computer system. This indication may be a flag that indicates that the purchaser is making a purchase using a currency other than the base currency. The indication may be accompanied by purchase information. Purchase information may contain information about the item or items the purchaser is purchasing. Purchase information may include: product codes linked to the items the purchaser is purchasing, item names, quantities of items, prices of the items in the purchaser's currency, prices of the items in the base currency, the exchange rate used, biographical information of the purchaser, the IP address of the purchaser, the date, and/or time. Of course, as those with skill in the art will recognize, other data may also be transmitted to host computer system 120.

In response to receiving the flag and/or purchase information, host computer system 110 may link a purchase identifier to the purchase information. This purchase identifier may be stored with the purchase information by host computer system 120. The purchase identifier may also be transmitted to the client computer system 120. The plug-in or other code that interacts with the host computer system 110 may be configured to receive this purchase identifier and at least temporarily store it.

The purchase identifier may be routed to the merchant computer system 130 by the client computer system 110. This may serve as an indication to merchant computer system 130 that the purchaser intends to pay in a currency different from the base currency. A flag may be transmitted from the client computer system 110 to merchant computer system 130 to alert merchant computer system 130 of payment occurring in a currency other than the base currency. Merchant computer system 130 may transmit this payment identifier to host computer system 120 to retrieve and/or confirm information associated with the transaction. For example, some of the purchase information received from client computer system 110 may be confirmed. More specifically, the costs in the purchaser's currency, the conversion rate, product codes, costs in the base currency, and/or the date and time of the transaction may be confirmed with host computer system 120.

Following details of the purchase transaction being confirmed and/or exchanged between merchant computer system 130 and conversion host computer system 120, payment may be made by the purchaser from client computer system 110 to merchant computer system 130. Payment may be in the purchaser's currency. The merchant can be assured that the amount received in the purchaser's currency corresponds to the prices of the items purchased in the base currency because the conversion has been handled by host computer system 130. Merchant computer system 130 may route the transaction through payment gateway computer system 150 for authorization and settlement.

While not illustrated to maintain simplicity, it should be understood that communication between any components of inline conversion system 100 may involve the use of a network, as the Internet. Further, more than one network may be used. Also, it should be understood that host computer system 120 may handle transactions for a plurality of different merchant computer systems. For example, merchants that have no existing relationship with each other may transact with host computer system 120. Further, multiple different client computer systems, with associated purchasers, may interact with host computer system 120 and multiple different merchant computer systems.

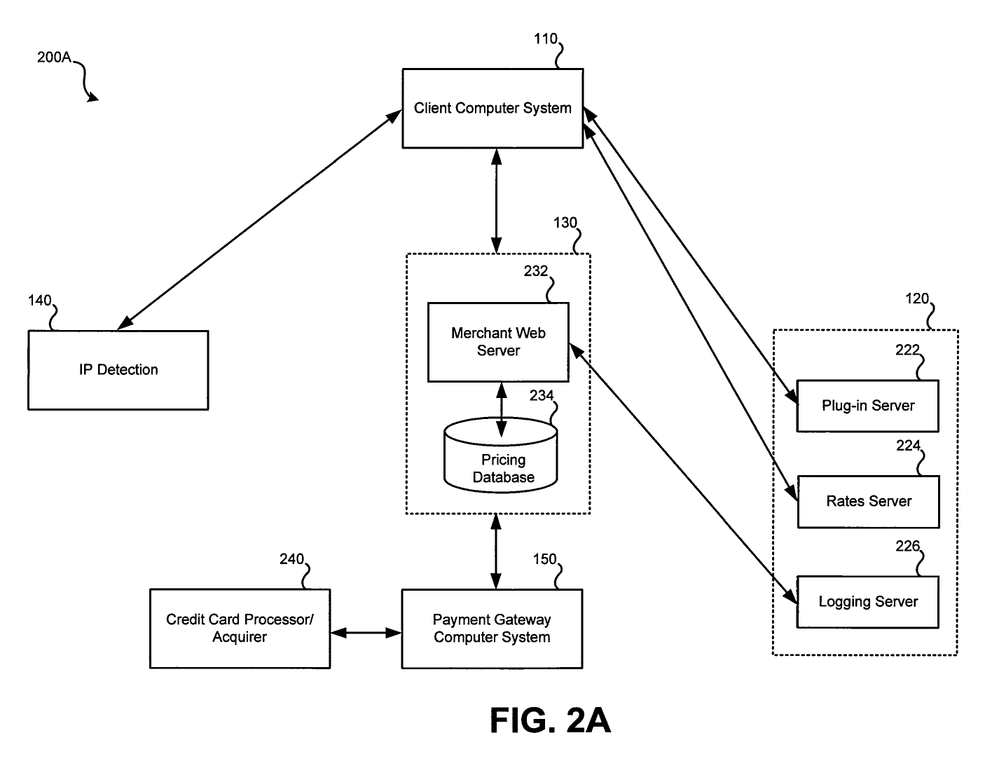

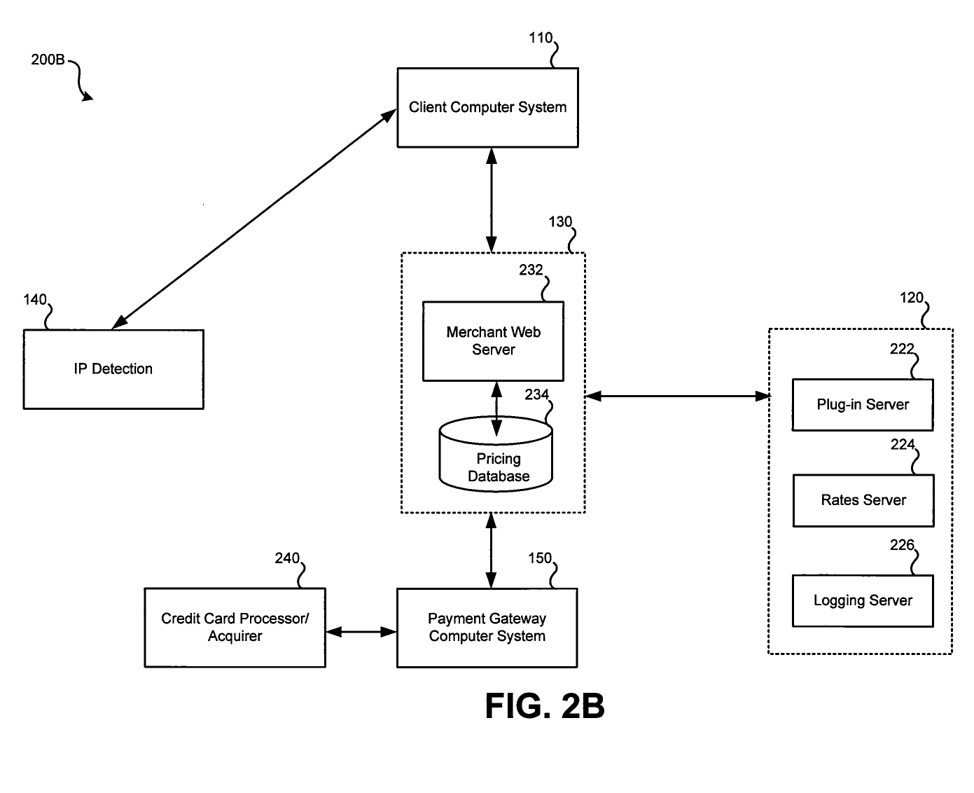

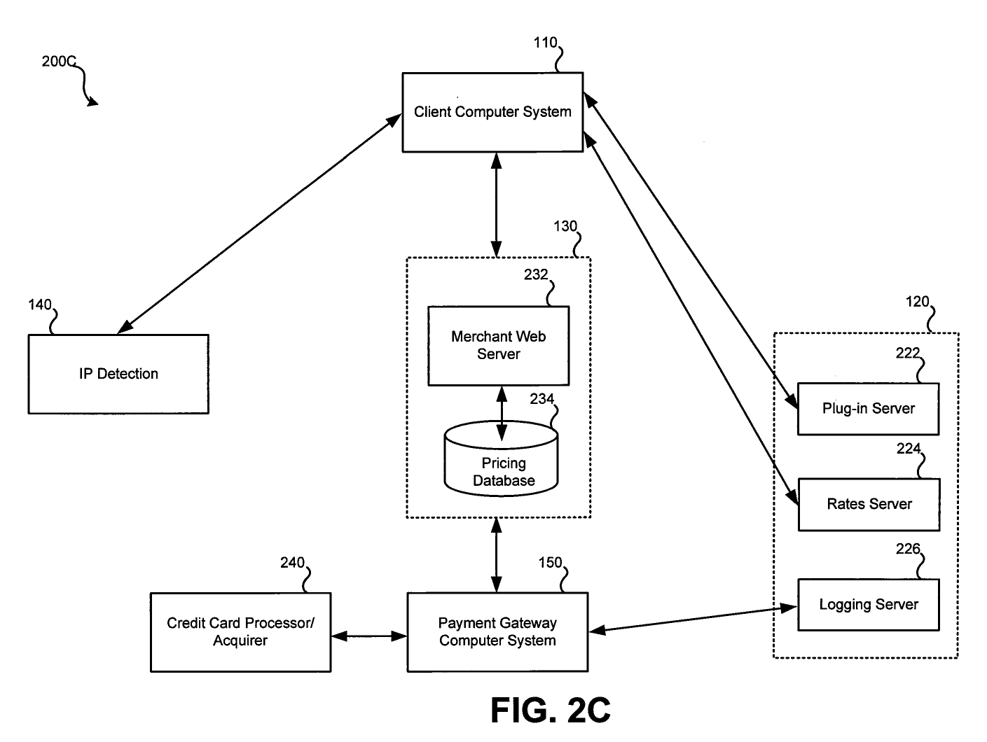

FIG. 2A illustrates a high level diagram of another embodiment of an inline currency conversion system 200A. Inline currency conversion system 200A may represent inline currency conversion system 100 of FIG. 1, or may represent a different form of an inline currency conversion system. In inline currency conversion system 200A, merchant computer system 130 contains multiple components: merchant web server 232 and pricing database 234. Merchant web server 232 may represent a computer system that receives and responds to requests from client computer system 110 for one or more webpages. Pricing information may be stored in pricing database 234. For example, while prices may be displayed on various webpages transmitted by merchant web server 232 to client computer system 110, before a purchase is completed, the price of the items involved in the purchase may be retrieved and/or confirmed by performing a lookup based on the product codes of items being purchased in the pricing database.

Conversion host computer system 120 may contain multiple components: a plug-in server 222, a rates server 224, and a logging server 226. Plug-in server 222 may respond to requests by client computer systems to download the currency conversion plug-in. If client computer system 110 requests and receives a webpage from merchant web server 232, the webpage may contain a reference to the plug-in. For example, a call for the plug-in may be through HTML DOM (Document Object Model) and JAVASCRIPT. These components may be paired using JSONP (JAVASCRIPT Object Notation with Padding). The code for the plug-in may be requested and received from plug-in server 222.

Rates server 224 may receive and respond to requests for conversion rates. Client computer system 110 may transmit a request to rates server 224 identifying a particular country or currency and the base currency. Rates server 224 may respond to client computer system 110 with a conversion rate between the currency (or the currency of the country) identified in the request and the merchant's base currency. Rates server 224 may access a database that contains conversion rates for multiple currencies. These conversion rates may be updated periodically, such as once per day, once per hour, once per minute, or sporadically as new conversion rate information becomes available. Rates server 224 may also receive purchase information from client computer system 110 via the plug-in that has been loaded at client computer system 110. Rates server 224 may receive purchase information, such as product codes linked with items the purchaser intends to purchase, prices in the base currency, and/or prices in the purchaser's currency. Some or all of this purchase information received by rates server 224 may be stored. Rates server 224 may store a purchase identifier linked to the purchase information received from client computer system 110. Rates server 224 may transmit the purchase identifier to client computer system 110.

Logging server 226 may respond to requests for purchase information from merchant web server 232. Merchant web server 232 may transmit the purchase identifier (that was initially transmitted by rates server 224 to client computer system 110) to logging server 226. Logging server 226 may access a database that stores a plurality of purchase identifiers along with purchase information linked to the purchase identifier. Logging server 226 may look up the purchase information based on the purchase identifier. Logging server 226 may transmit purchase information to merchant web server 232. In some embodiments, logging server 226 may confirm purchase information, such as a conversion rate, transmitted by merchant web server 232 to logging sever 226.

When payment from the purchaser operating client computer system 110 to the merchant associated with merchant computer system 130 is made, the payment may be authorized and settled through payment gateway computer system 150, which may be in communication with credit card processor/acquirer 240. As in FIG. 1, client computer system 110 may communicate with IP Detection system 140 to determine the country and/or currency likely associated with the purchaser using client computer system 110. In some embodiments, while IP detection system 140 may identify and/or select a particular currency and/or country, a purchaser using client computer system 110 may have the ability to override the country and/or currency selected by IP detection system 140. This may be useful in a situation where a purchaser is using a computer outside of their home country: for example, an Englishman using client computer system 110 located in France (which uses the Euro). In this example, the IP detection system 140 may identify the purchaser's currency as the Euro and/or his country as France, while the purchaser would actually prefer to be associated with Britain and/or the Pound Sterling. Instead of using IP detection computer system 140, a customer may, via preference setup, select a location preference. In some embodiments, a listing of different currencies may be presented to the customer, thus allowing the customer to select his preferable currency.

While not illustrated, it should be understood that communication between any components of inline conversion system 200 may involve the use of a network. Further, more than one network may be used. For example, communication between two components, such as client computer system 110 and merchant computer system 130, may involve multiple networks: if client computer system 110 is a smart phone, communication with merchant computer system 130 may involve using a wireless carrier's private wireless network and also the Internet. As another example, communication between credit card processor/acquirer 240 and payment gateway computer system 150 may involve the Internet and/or a private network connection.

FIG. 2B illustrates a high level diagram of inline currency conversion system 200B. In inline currency conversion system 200B, rather than components of conversion host computer system 120 communicating directly with client computer system 110, client computer system 110 communicates with merchant computer system 130, but not directly with host computer system 120. Rather, merchant computer system 130 communicates with host computer system 120. Inline currency conversion system 200B may represent inline currency conversion system 100 of FIG. 1, or may represent a different inline currency conversion system.

In inline currency conversion system 200B, conversion rates for multiple currencies may be periodically transmitted from host computer system 120 to merchant computer system 130. More specifically, these conversion rates may be transmitted by rates server 224 of host computer system 120 to merchant web server 232. These conversion rates may be stored in a database, table, or some other arrangement by merchant computer system 130. Also, code and data associated with the plug-in may be stored by merchant computer system 130. Therefore, when client computer system 110 receives a webpage from merchant computer system 130, code associated with the conversion plug-in and conversion rate information may also be retrieved by client computer system 110 from merchant computer system 130. As such, in in-line currency conversion system 200B, client computer system 110 may not communicate directly with host computer system 120.

In some embodiments, rather than host computer system 120 periodically transmitting conversion rates to merchant computer system 130, upon receiving an indication from client computer system 110, such as a flag and/or a currency code, merchant computer system 130 may transmit an amount (in the merchant's currency) and a currency code to the host computer system. Host computer system would then respond with an amount to be paid to the merchant by the purchaser in the purchaser's currency.

FIG. 2C illustrates a high level diagram of another embodiment of an inline currency conversion system. In in-line currency conversion system 200C, merchant computer system 130 does not communicate directly with host computer system 120. Rather, client computer system 110 communicates with host computer system 120. Host computer system 120 also may communicate with payment gateway computer system 150. Such a configuration may limit the amount of modification required to merchant computer system 130 in order to process payments in the purchaser's currency.

In in-line currency conversion system 200C, when client computer system 110 requests a webpage from merchant computer system 130, client computer system 110 may receive instructions to contact host computer system 120 to download the conversion plug-in. Host computer system 120, or, more specifically, plug-in server 222, May transmit data associated with the plug-in to client computer system 110. Based upon the currency associated with the purchaser using client computer system 110, host computer system 120 may be contacted in order to determine a conversion rate associated with the purchaser's currency and the base currency of the merchant. Host computer system 120, or more specifically, rates server 224, may transmit the conversion rate to client computer system 110.

When the purchaser using client computer system 110 makes a purchase, the payment may be processed by merchant computer system 130 in the merchant's base currency. For example, if the merchant's base currency is the United States Dollar, every transaction submitted for authorization by merchant computer system 130 to payment gateway computer system 150 may be in the form of United States Dollars. The transaction submitted by merchant computer system 130 to payment gateway computer system 150 may include a flag and/or transaction identifier that indicates the purchase should be authorized and settled in some currency other than the merchant's base currency.

Payment gateway computer system 150 may communicate with host computer system 120 in order to confirm and receive information regarding the purchase by the purchaser. Host computer system 120, or more specifically, logging server 226, may transmit purchase information, pricing information and/or conversion information to payment gateway computer system 150. Based upon the information received by payment gateway computer system 150 from merchant computer system 130 and host computer system 120, payment gateway computer system 150 may authorize and settle the payment by the purchaser in the purchaser's currency with credit card processor/acquirer 240.

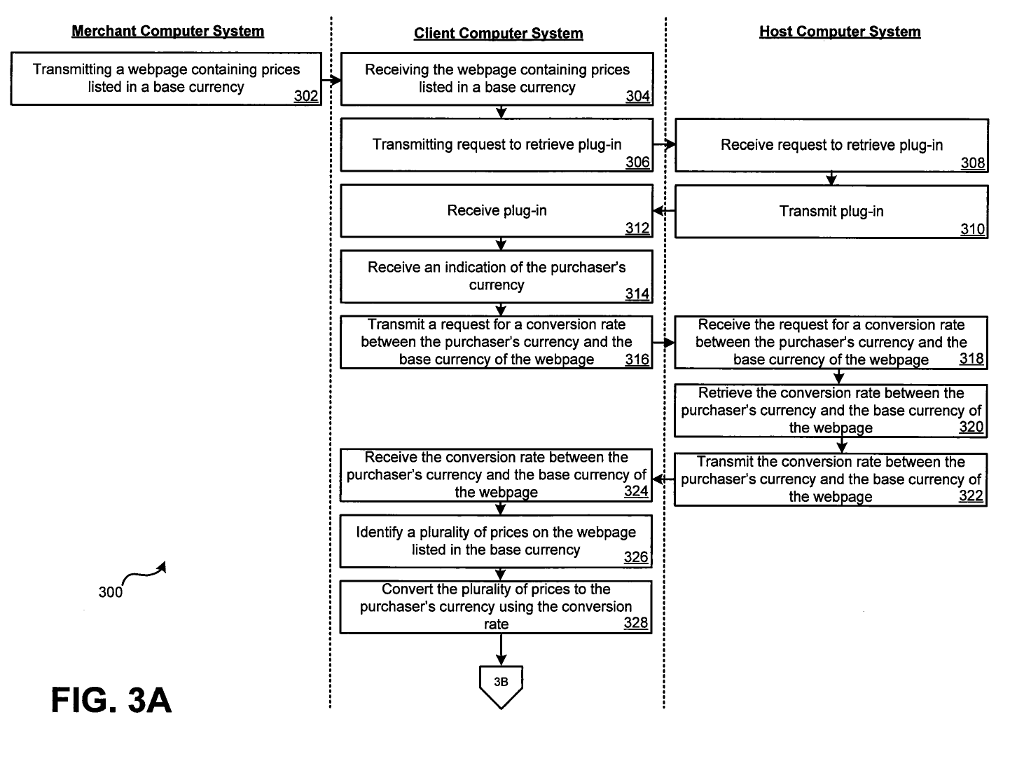

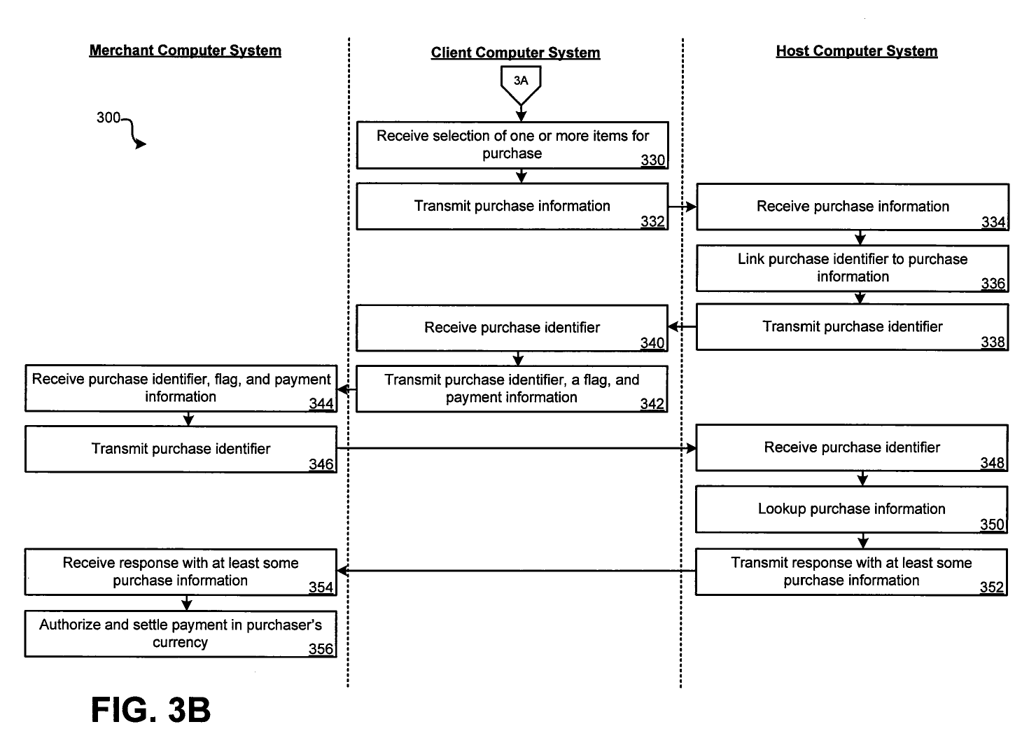

FIGS. 1 and 2A-2C illustrate various embodiments of in-line currency conversion systems. Each of these systems may be used to conduct various methods of conducting in-line currency conversions. The methods illustrated in FIGS. 3-5 illustrate methods which may be performed using the systems described in FIGS. 1 and 2A-2C. It should be understood that these systems may also perform other methods. Likewise, the methods described in FIGS. 3-5 may be performed using other systems.

FIGS. 3A and 3B illustrate a swim diagram of a method 300 of conducting an inline currency conversion, such as for an online purchase transaction. Method 300 may be performed using system 200A, or may be performed using some other system. FIGS. 3A and 3B illustrate information exchanged between a merchant computer system, a client computer system, and a host computer system. Merchant computer system may represent merchant computer system 130 of FIG. 2A. Client computer system may represent client computer system 110 of FIG. 2A. Host computer system may represent host computer system 120 of FIG. 2A. While method 300 is illustrated as involving a merchant computer system, a client computer system, and a host computer system communicating directly with each other, it should be understood that other systems may be present and involved in communications. For example, one or more networks, such as the Internet, may be used for communication between these three computer systems.

At block 302 a webpage may be transmitted by the merchant computer system to the client computer system. This webpage may contain one or more prices. These prices may be listed in the merchant's base currency. The webpage may also have a link or other code that references a currency conversion plug-in. For example, this link or other code may be part of a script that is configured to be executed by the client computer system. The currency conversion plug-in may be implemented using HTML DOM (Document Object Model) and JAVASCRIPT. These components may be paired using JSONP. At block 304, the webpage containing the prices listed in the base currency may be received by the client computer system.

If the webpage requires that the client computer system acquire a conversion plug-in, and the conversion plug-in has not previously been loaded onto the client computer system, client computer system may transmit a request to the host to retrieve the plug-in at block 306. If the plug-in is already present on the client computer system, method 300 may skip to block 314 or 316 (if the purchaser's currency is already stored). At block 308, the host computer system may receive the request to retrieve data associated with the plug-in from the client computer system. At block 310, the plug-in may be transmitted to the client computer system. At block 312, the client computer system may receive the plug-in. The plug-in may then be executed by the client computer system.

At block 314, the client computer system may receive an indication of the purchaser's currency. This may occur in several ways. The indication of the purchaser's currency may be received directly from the purchaser. For example, the purchaser, possibly by the plug-in, may be presented with a listing of multiple different countries and/or currencies. The purchaser may then select which country the purchaser is located in and/or which currency the purchaser wishes to conduct the purchase in. If the purchaser selects a country, the plug-in may determine a currency associated with that country. If more than one currency is associated with that country, the purchaser may be prompted to select one of the currencies. In some embodiments, instead of the purchaser selecting a country and/or currency, an IP detection system is used to determine a location of the client computer system. Based on the IP address of the client computer system, the IP detection system may identify a country associated with the IP address. Based on the country identified, a currency may be selected for the purchaser. If the IP address may be associated with more than one country, a list of multiple currencies (which may have been narrowed down based on the IP address) may be presented to the purchaser for selection of one currency.

At block 316, a request for a conversion rate between the purchaser's currency (which was identified at block 314) and the base currency of the webpage may be transmitted by the client computer system. For example, if the purchaser's currency is determined to be the Euro and the base currency of the webpage is the United States Dollar, the request for the conversion rate may identify that a rate between United States Dollars and Euros is needed. At block 318, this request may be received by the host computer system from the client computer system.

At block 320, the conversion rate between these two currencies may be retrieved by the host computer system. A database accessible by the host computer system may be maintained that contains up-to-date conversion rates for various currencies. This database may be accessed in order to retrieve the conversion rate between the purchaser's currency and the base currency of the merchant. This database maintained at the host computer system may be updated periodically, such as once per day, once per hour, or every minute. At block 322, the conversion rate between the base currency of the webpage and the purchaser's currency (which may have been retrieved at block 320) may be transmitted to the client computer system. An expiration time and/or date may also be transmitted along with the conversion rate. The expiration time/date may be used to indicate when the conversion rate will no longer be valid. For example, if a purchaser using the client computer system loads a webpage at 4 PM, the purchaser may leave his Internet browser and the webpage open for an indefinite period of time. If the purchaser leaves the webpage open for a significant amount of time, such as until 4 PM the next day, the conversion rate between the purchaser's currency and the base currency of the webpage may have changed. Therefore, to prevent inaccurate prices from being displayed to the purchaser, after a predefined period of time, which may be indicated by the expiration time/date, the conversion rate transmitted by the host computer system to the client computer system at block 322 is no longer valid. This may prevent an outdated conversion rate from being used by the client computer system. Further, this may prevent the purchaser from completing a purchase transaction with the merchant without first acquiring an updated conversion rate from the host computer system. In some embodiments, the client computer system may seek a “latest-rate” often, such as every minute or each time the customer using the client computer system adds an item to his electronic shopping cart.

At block 324, the conversion rate may be received by the client computer system. Also, the expiration time/date of the conversion rate may be received by the client computer system. In some embodiments, the plug-in may store a predefined time period after which the conversion rate is no longer valid. For example, if the predetermined time period is one hour, then if the conversion rate is received by the client computer system at 4:27 PM, the plug-in may invalidate the conversion rate at 5:27 PM. If, along with the conversion rate, an expiration time/date is transmitted by the host computer system to the client computer system, the transmitted expiration time/date may be used instead of the predefined time period. Of course, in some embodiments, the host computer system may transmit a predetermined time period instead of a specific expiration time/date.

At block 326, one or more prices present on the webpage that are listed in the base currency of the merchant may be identified by the plug-in. These prices may be identified through their association with a particular symbol. For example, if the base currency of the website is the United States Dollar, the plug-in may identify each price because it is preceded by the “$” character. Information on how to identify each price appearing on the webpage may be provided by the merchant to the host computer system and/or embedded in the plug-in at some earlier time. For example, besides parsing the webpage for the “$” sign, the webpage may be parsed for a particular HTML code that is used to indicate a price in the merchant base currency.

At block 328, the prices identified in the base currency of the merchant at block 326 may be converted using the conversion rate received at block 324 to the purchaser's currency. Therefore, as displayed to the purchaser, the webpage displays prices in the purchaser's currency. Each price displayed in the purchaser's currency may have the same, or approximately the same, value as the corresponding price in the base currency. Displaying prices in the purchaser's currency may also involve inserting, or substituting, a symbol to indicate that the purchaser's currency is being displayed. For example, if the base currency of the website is the United States Dollar and each price is preceded by the “$” sign, and the purchaser's currency is the Euro,“$” may be substituted with “ [symbol] ,” so that the purchaser is aware that the prices listed are in Euros and not United States Dollars.

Method 300 continues on FIG. 3B. At block 330, the client computer system may receive the selection of one or more items that the purchaser wishes to purchase. This may involve the purchaser “placing” items in an electronic shopping cart. Product codes and/or prices (in the base currency and/or the purchaser's currency) may be stored by the client computer system. Once the purchaser has determined he wishes to complete the purchase for the items he has selected at block 330, purchase information associated with his selections may be transmitted from the client computer system to the host computer system at block 332. This purchase information may include information such as: a product code associated with each of the items the purchaser is purchasing, a price in the purchaser's currency for each of the items being purchased, a price in the merchant's base currency for each item being purchased, the quantities of items being purchased, the date and time of the transaction, the expiration date and time of the conversion rate, the conversion rate used to convert between the base currency of the merchant and the purchaser's currency, a total cost for all of the items in the purchaser's currency, a total cost for all of the items in the base currency, a password, and/or information sufficient to identify the purchaser and/or the client computer system. The information sufficient to identify the purchaser and/or the client computer system may include the IP address of the client computer system, a username of the purchaser, a password of the purchaser, an address of the purchaser, and/or a phone number of the purchaser. As those of skill in the art will recognize, other information may also be used to identify the purchaser and/or the client computer system. Information transmitted may be encrypted or otherwise secured to limit fraud and/or theft of the customer's information.

At block 334, this purchase information may be received by the host computer system from the client computer system. The purchase information may be updated by the host computer system and/or checked for accuracy. For example, it may be confirmed by the host computer system that the purchase information contains a valid conversion rate. In some embodiments, the conversion rate linked to the purchase information may be updated by the host computer system.

At block 336, some or all of the purchase information received from the client computer system may be stored by the host computer system. Further, a purchase identifier may be linked to this purchase information. This purchase identifier may be a number, or some other combination of characters, that is linked with a particular set of purchase information. The purchase identifier, along with the purchase information, may be stored in a database, a table, or any other appropriate storage configuration. At block 338, this purchase identifier may be transmitted from the host computer system to the client computer system. At block 340, the client computer system may receive and store the purchase identifier.

At block 342, some or all of the payment information and/or the purchase identifier received from the host computer system at block 340 may be transmitted to the merchant computer system. A flag may also be transmitted from the client computer system to the merchant computer system indicating that the purchaser wishes to conduct the purchase in a currency other than the base currency associated with the merchant. The payment information transmitted by the client computer system to the merchant computer system may also include indications of the items the purchaser is intending on purchasing. This may include product codes, quantities, credit card account information (or some other account that is to be used to complete the purchase, such as a debit card account, gift card account, or stored value card account), coupon codes, gift wrapping instructions, gift messages, shipping information, biographical information about the purchaser, and/or prices in the base currency of the merchant and/or in the purchaser's currency. A flag may also be transmitted by the client computer system to the merchant computer system at block 342. This may serve as an indication to the merchant computer system that the host computer system should be contacted in order to complete the purchase transaction. At block 344, the purchase identifier, payment information, and the flag may be received by the merchant computer system. Based upon product codes received at block 344, prices in the base currency of the merchant may be determined by accessing a pricing database, such as pricing database 234 of FIG. 2A. A pricing database may be used instead of receiving a price from the client computer system in order to minimize the chance for fraud of a purchaser altering a price listed on the webpage and attempting to purchase the item at a discount.

At block 346, the purchase identifier may be transmitted by the merchant computer system to the host computer system. Along with the purchase identifier, prices of the items the purchaser intends on purchasing in the merchant's base currency may be transmitted to the host computer system. At block 348, the purchase identifier and possibly prices of the items the purchaser intends on purchasing are received by the host computer system.

At block 350, the purchase identifier received by the host computer system from the merchant computer system may be used to look up the purchase information received from the client computer system at block 334. A response including some or all of the purchase information may be transmitted by the host computer system to the merchant computer system at block 352. This response may include the amount of the transaction in the purchaser's currency, the cost of each item in the purchaser's currency, date and time information, and/or the conversion rate used to convert the base currency to the purchaser's currency. Other information may also be included in the response from the host computer system to the merchant computer system. At block 354, the response with at least some of the purchase information is received by the merchant computer system.

At block 356 the merchant computer system, possibly using a payment gateway computer system such as payment gateway computer system 150 of FIG. 2A, may authorize and settle the purchase transaction between the purchaser and the merchant. The transaction may be authorized and settled in the purchaser's currency. The merchant may rest assured that the value of the amount in the purchaser's currency is equivalent, or roughly equivalent, to the value in the merchant base currency because the conversion has been handled by the host computer system. The entity operating the host computer system may guarantee the merchant that the value of the purchaser's currency paid to the merchant is equal, or equal within a given margin of error, to the same value in the base currency. The entity operating the host computer system may cover the lost funds of any discrepancies due to an incorrect or outdated conversion rate for the merchant.

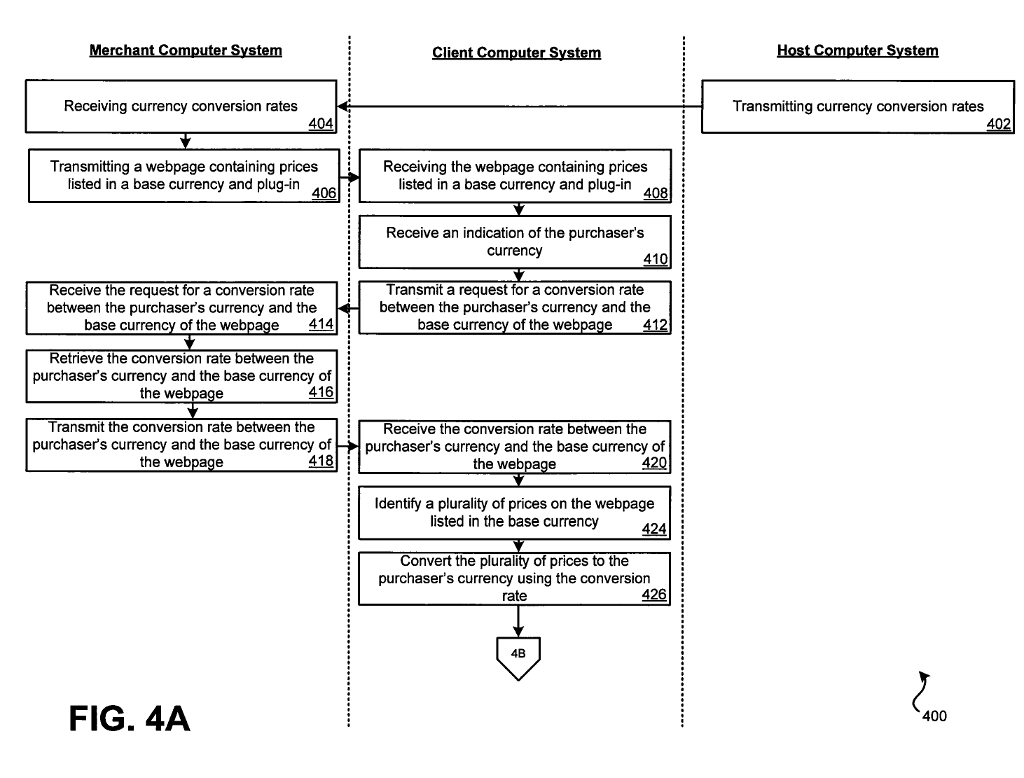

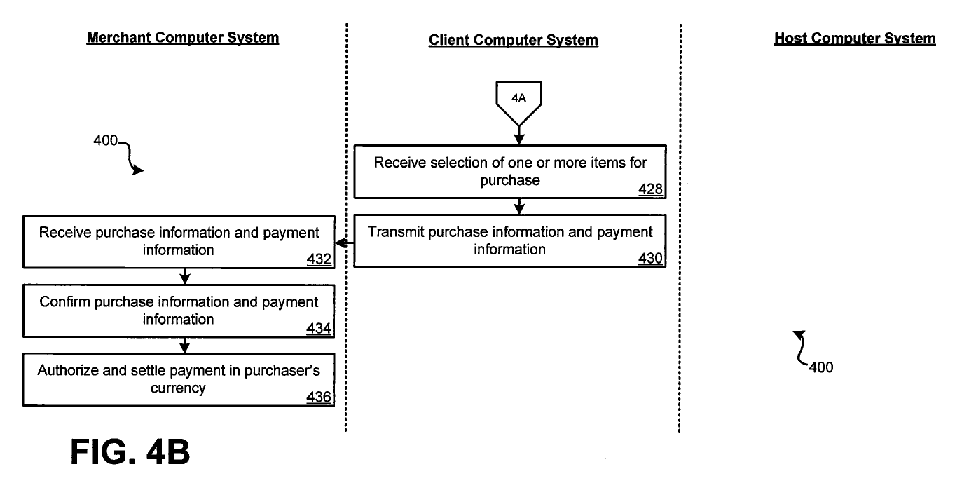

Other methods may also be possible. FIGS. 4A and 4B illustrate a swim diagram of a method 400 of conducting an inline currency conversion. Method 400 may use an in-line currency conversion system such as in-line currency conversion system 200B of FIG. 2B. In method 400, the client computer system may not communicate directly with the host computer system. Rather, the host computer system may communicate with the merchant computer system, and the merchant computer system may communicate with the client computer system, but no direct communication may occur between the client computer system and the host computer system.

At block 402, currency conversion rates between a plurality of currencies and the merchant's base rate may be transmitted by the host computer system to the merchant computer system. The transmission of these currency conversion rates may happen periodically, such as once per day or once per hour. Alternatively, the currency conversion rates may be transmitted to the merchant computer system whenever there is a significant change in the conversion rate between the merchant's base currency and some other currency. In some embodiments, the merchant computer system may periodically request updated currency conversion rates from the host computer system. At block 404, currency conversion rates transmitted by the host computer system may be received and stored by the merchant computer system.

Following a request from a client computer system, merchant computer system may transmit a webpage to the client computer system at block 406. This webpage may contain prices in the merchant's base currency. These prices may be listed in the merchant's base currency. The webpage may also have a link or other code that references a currency conversion plug-in. For example, this link or other code may be part of a script that is configured to be executed by the client computer system. The currency conversion plug-in may be implemented using HTML DOM (Document Object Model), more specifically, the plug-in may be implemented using JAVASCRIPT. In some embodiments, the plug-in is transmitted to the client computer system by the merchant computer system. In some embodiments, the code of the plug-in is directly encoded into the webpage retrieved by the client computer system. The webpage containing the prices listed in the merchant's base currency and the plug-in are received by the client computer system at block 408.

At block 410, an indication of the purchaser's currency is received. This step may be performed similarly to block 314 of FIG. 3A. At block 412, a request for a conversion rate between the purchaser's currency which was identified at block 410, and the base currency of the webpage may be transmitted to the merchant computer system by the client computer system. At block 414, the request for the conversion rate may be received by the merchant computer system. At block 416, the conversion rate between the purchaser's currency and the base currency of the webpage may be retrieved by the merchant computer system from a table, database, or some other appropriate storage arrangement. The conversion rate may have been received by the merchant computer system at block 404 from the host computer system. In some embodiments, if the client computer system requests a conversion rate not stored by the merchant computer system, the merchant computer system may be able to request that particular conversion rate from the host computer system. At block 418, the conversion rate between the purchaser's currency and the base currency of the webpage may be transmitted by the merchant computer system to the client computer system. At block 420, this conversion rate may be received by the client computer system.

Alternatively, in some embodiments, rather than the client computer system requesting a conversion rate from the merchant computer system, a table, a database, or some other storage format, of multiple different conversion rates may be transmitted by the merchant computer system to the client computer system when the plug-in and web page are initially transmitted to the client computer system at block 406.

At block 424, a plurality of prices on the webpage that are listed in the merchant's base currency may be identified by the client computer system. These prices may be identified because each is associated with a particular symbol. For example, if the base currency of the website is the United States Dollar, the plug-in may identify each price because it is preceded by the “$” character. Information on how to identify each price appearing on the webpage may be provided by the merchant to the host computer system at some earlier time. For example, besides parsing the webpage for the “$” sign, the webpage may be parsed for a particular HTML code that is used to indicate a price in the merchant base currency.

At block 426, the prices identified in the base currency of the merchant at block 424 may be converted using the conversion rate received at block 420 to the purchaser's currency. Therefore, as displayed to the purchaser, the webpage displays prices in the purchaser's currency. Displaying prices in the purchaser's currency may also involve inserting, or substituting, a symbol to indicate that the purchaser's currency is being displayed. For example, if the base currency of the website is the US Dollar with each price is preceded by the “$” sign, and the purchaser's currency is the Euro, the “$” sign may be substituted with the “ [symbol] ” sign, so that the purchaser is aware that the prices listed are in Euros and not United States Dollars.

Method 400 continues on FIG. 4B. At block 428, the client computer system may receive the selection of one more items that the purchaser wishes to purchase. This may involve the purchaser “placing” items in an electronic shopping cart or otherwise selecting the items the purchaser wishes to acquire. Product codes and/or prices (in the base currency and/or the purchaser's currency) may be stored by the client computer system of the items the purchaser intends on purchasing. Once the purchaser has determined he wishes to complete the purchase for the items he selected at block 428, purchase information associated with his selections may be transmitted from the client computer system to the merchant computer system at block 430. This purchase information may include information such as: a product code associated with each of the items the purchaser is purchasing, the quantity of each item being purchased, a price in the purchaser's currency for each of the items being purchased, a price in the merchant's base currency for each item being purchased, the date and time of the transaction, the expiration date and time of the conversion rate, the conversion rate used to convert between the base currency of the merchant and the purchaser's currency, a total cost for all of the items in the purchaser's currency, a total cost for all of the items in the base currency, and/or information sufficient to identify the purchaser and/or the client computer system. The information sufficient to identify the purchaser and/or the client computer system may include the IP address of the client computer system, a username of the purchaser, a password of the purchaser, an address of the purchaser, and/or a phone number of the purchaser. As those of skill in the art will recognize, other information may also be used to identify the purchaser and/or the client computer system. Encryption may be used to protect the purchase information transmitted.

At block 430, payment information may also be transmitted to the merchant computer system. The payment information transmitted by the client computer system to the merchant computer system may include credit card account information (or some other account that is to be used to complete the purchase, such as a debit card account, gift card account, or stored value card account), biographical information about the purchaser, and/or prices in the base currency of the merchant. A flag may also be transmitted by the client computer system to the merchant computer system at block 430. This may serve as an indication to the merchant computer system that the host computer system should be contacted in order to complete the purchase transaction. At block 432, some or all of the purchase information and payment information may be received by the merchant computer system from the client computer system. The information transmitted at blocks 430 and 432 may be encrypted to protect the information exchanged.

At block 434, the merchant computer system may store and/or confirm some or all of the purchase information and payment information. For example, the merchant computer system may confirm the appropriate price for each item the purchaser wishes to purchase, or the total price of all the items the purchaser wishes to purchase, in the purchaser's currency using the appropriate currency conversion rate received from the host computer system at block 404 and the price of each item the purchase desires to purchase in the merchant's base currency, which may be stored in a pricing database, such as pricing database 234 of FIG. 2B. Another confirmation which may occur at block 434 may include the merchant computer system confirming that the conversion rate provided to the client computer system at block 420 is still valid. This may involve ensuring that the current conversion rate has not changed by more than a certain amount from the conversion rate transmitted to the client computer system. If the current conversion rate has changed, the purchaser may be used prompted to confirm the new prices in the purchaser's currency, or may be required to resubmit the purchases.

At block 436, payment in the purchaser's currency may be authorized and settled by the merchant computer system. This may involve communication with a payment gateway computer system, such as payment gateway computer system 250 of FIG. 2B. The merchant may rest assured that the value of the amount in the purchaser's currency is equivalent, or roughly equivalent, to the value in the merchant base currency because the conversion rates have been set by the host computer system.

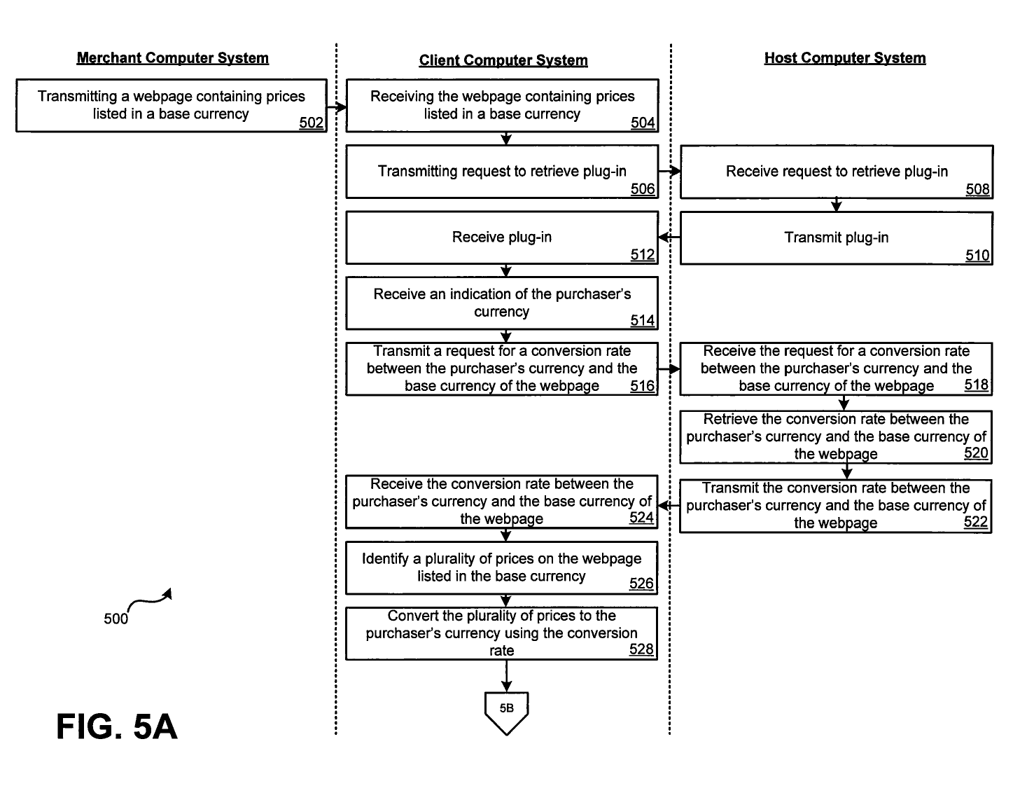

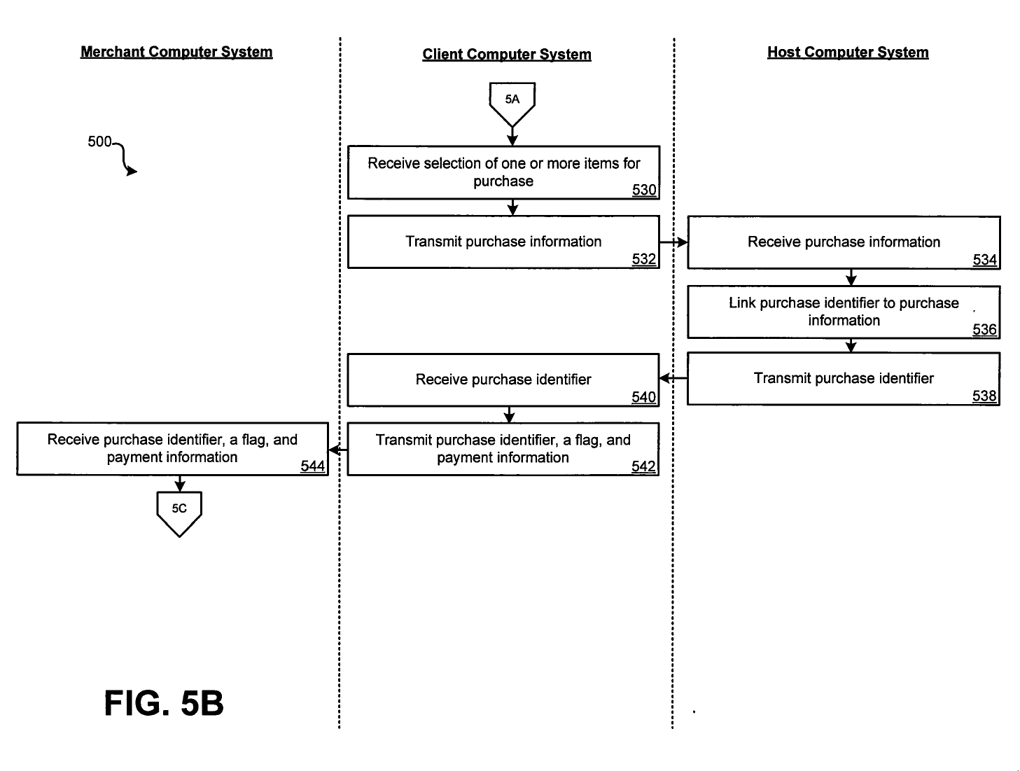

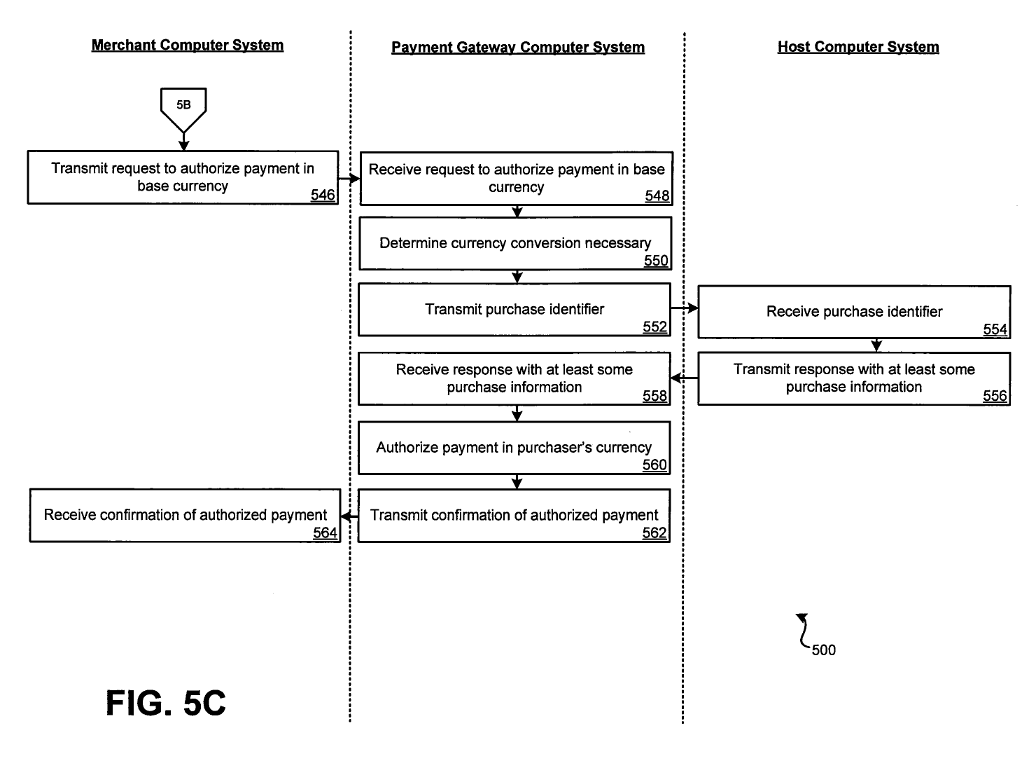

Other methods may also be possible. FIGS. 5A-5C illustrate a swim diagram of a method 500 of conducting an inline currency conversion. Method 500 may use an in-line currency conversion system such as in-line currency conversion system 200C of FIG. 2C. In method 500, the merchant computer system may not communicate directly with the host computer system. Rather, the client computer system and the payment gateway computer system may communicate with the host computer system. Such a configuration may allow the merchant operating the merchant computer system to allow a purchaser to conduct a purchase in the purchaser's currency while decreasing the modifications necessary to the merchant computer system to implement such an inline currency conversion method.

Method 500 may begin similar to method 300 of FIG. 3. Blocks 302 through 344 of FIGS. 3A and 3B may correspond to blocks 502 through 544 of FIGS. 5A and 5B. At block 546 of FIG. 5C, the merchant computer system may transmit a request to authorize payment in the merchant base currency to a payment gateway computer system. This request may include a flag that serves to indicate that a conversion to another currency is necessary for the purchase to be completed in the purchaser's currency. The request may include the purchase identifier. At block 548, the request to authorize payment in the merchant's base currency may be received by the payment gateway computer system, such as payment gateway computer system 150 of FIG. 2C.

At block 550, the payment gateway computer system may determine that a currency conversion is necessary for the payment to be authorized. This determination may be based on the flag and/or purchase identifier that was included in the request to authorize payment received from the merchant computer system. At block 552, the payment gateway computer system may transmit the purchase identifier to the host computer system. The host computer system may receive the purchase identifier from the payment gateway computer system at block 554.

A response, including some or all of the purchase information linked to the purchase identifier, may be transmitted by the host computer system to the payment gate computer system at block 556. This response may include an identification of the purchaser's currency, the amount of the transaction in the purchaser's currency, the cost of each item in the purchaser's currency, the total cost of the purchaser's purchase (in either the base currency or the purchaser's currency), date and time information, and/or the conversion rate used to convert the base currency to the purchaser's currency. Other information may also be included in the response from the host computer system to the payment gateway computer system. At block 558, the response with at least some of the purchase information is received by the payment gateway computer system.

At block 560, the payment gateway computer system may authorize payment in the purchaser's currency. At block 562, a confirmation of the authorized payment may be transmitted to the merchant computer system. This confirmation may indicate that the payment was authorized for a particular amount in the purchaser's currency and/or the merchant's base currency. At block 564, the merchant computer system may receive confirmation of the authorized payment in the purchaser's currency and/or the merchant's base currency. Thereafter, the transaction may be settled with a credit card processor/acquirer, such as credit card processor/acquirer 240 of FIG. 2C.

To be clear, the transmission of any of the information between the client computer system, merchant computer system, and host computer system as detailed in reference to FIGS. 1-5, may or may not be encrypted or otherwise protected. Such encryption may limit fraud and/or theft of the purchaser's information.

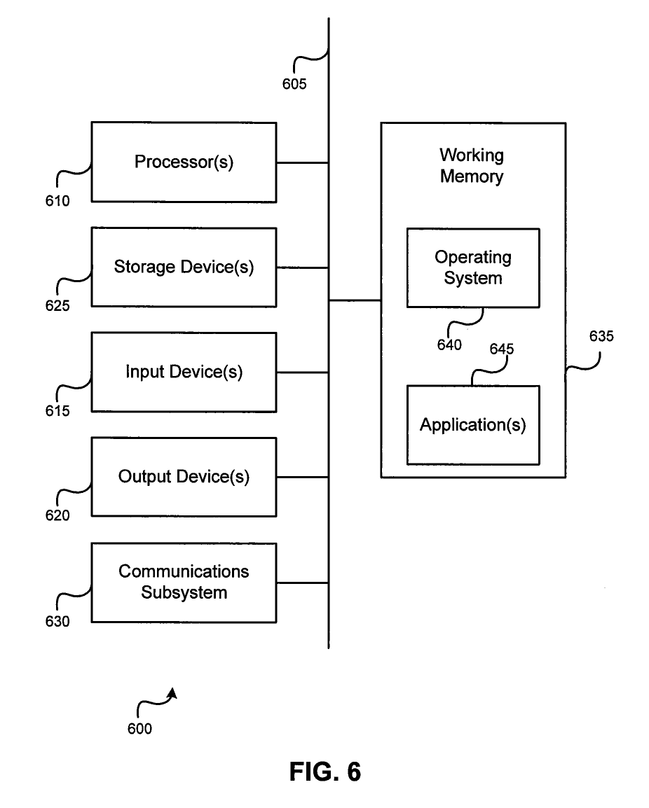

To perform the actions of the host computer system, merchant computer system, client computer system, payment gateway computer system or any other previously mentioned computing devices, a computer system such as that illustrated in FIG. 6 may be used. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (e.g., a removable medium, such as a compact disc), and or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for conducting an online payment using a currency other than a base currency of a webpage, the method comprising:
receiving, by a client computer system from a merchant computer system, the webpage;
receiving, by the client computer system, an indication of a purchaser's currency;
identifying, by the client computer system, a plurality of prices on the webpage, wherein:
the plurality of prices on the webpage are in the base currency of the webpage; and
the base currency of the webpage is different from the purchaser's currency;
transmitting, by the client computer system to a host computer system, a request for a conversion rate between the base currency of the webpage and the purchaser's currency;
receiving, by the client computer system from the host computer system, the conversion rate between the base currency and the purchaser's currency;
converting, by the client computer system, the identified plurality of prices on the webpage listed in the base currency to a plurality of prices in the purchaser's currency using the conversion rate received from the host computer system;
transmitting, by the client computer system to the host computer system, purchase information;
receiving, by the client computer system from the host computer system, in response to the purchase information, a purchase identifier linked to the purchase information; and
transmitting, by the client computer system to the merchant computer system, the purchase identifier linked to the purchase information.

2. The method of claim 1, further comprising transmitting, by the client computer system to the merchant computer system, payment information, wherein the payment information comprises an account number linked to the purchaser.

3. The method of claim 1, wherein the purchase information comprises an indication of the purchaser and at least one product code.

4. The method of claim 1, further comprising transmitting, by the merchant computer system to the host computer system, the purchase identifier.

5. The method of claim 4, further comprising receiving, by the merchant computer system from the host computer system, at least a portion of the purchase information linked with the purchase identifier.

6. The method of claim 5, wherein:
the purchase information linked with the purchase identifier comprises a price of an item to be purchased; and
the price of the item to be purchased is confirmed between the host computer system and the merchant computer system.

7. The method of claim 1, wherein the indication of the purchaser's currency is received from an IP detection system.

8. The method of claim 1, further comprising, authorizing, by the merchant computer system, the online payment in the purchaser's currency.

9. The method of claim 1, further comprising settling the online payment in the purchaser's currency, wherein a value of the purchaser's currency used to settle the online payment for the at least one item is approximately equal to a value of the base currency to settle the online payment for the at least one item.

10. The method of claim 1, wherein the plurality of prices converted using the conversion rate remain static for at least a period of time, wherein the period of time is selected from a group consisting of:
an hour;
a day;
a week;
a month; and
a session between the client computer system and the merchant computer system.

11. The method of claim 1, wherein the indication of a purchaser's currency is selected by the purchaser from a list of a plurality of currencies.

12. A system for converting prices on a webpage to a currency other than a base currency of the webpage, the system comprising:
a computer system, comprising a memory, wherein the memory is configured to provide the computer system with instructions, which when executed, cause the computer system to:
receive, from a client computer system, a request for a conversion rate between a base currency and a purchaser's currency, wherein:
the plurality of prices on the webpage are initially listed in the base currency; and
the base currency and the purchaser's currency are different currencies;
transmit, to the client computer system, the conversion rate between the base currency and the purchaser's currency;
receive, from the client computer system, purchase information, wherein:
the purchase information indicates that a purchaser intends to conduct a purchase through a merchant computer system using the conversion rate transmitted to the client computer system; and
the merchant computer system is separate from the host computer system;
transmit, to the client computer system, in response to receiving the purchase information, a purchase identifier linked with the purchase information;
receive, from the merchant computer system, the purchase identifier; and
transmit, to the merchant computer system, at least some of the purchase information linked with the purchase identifier.

13. The system of claim 12, wherein the purchase information comprises a price in the base currency and a price in the purchaser's currency.

14. The system of claim 12, wherein the plurality of prices converted using the conversion rate remain static for at least a period of time, wherein the period of time is selected from a group consisting of:
an hour;
a day;
a week;
a month; and
a session between the client computer system and the merchant computer system.

15. The system of claim 12, wherein the memory further comprises instructions that are configured to cause the computer system to periodically update conversation rates for a plurality of currencies, wherein the conversion rates for the plurality of currencies comprises the conversion rate between the base currency and the purchaser's currency.

16. The system of claim 12, wherein the computer system confirms a plurality of sets of purchase information with a plurality of merchants.

17. A system for conducting an online purchase in a currency other than a base currency of a webpage, the system comprising:
a computer system, comprising a memory, wherein the memory is configured to provide the computer system with instructions, which when executed, cause the computer system to:
receive, from a host computer system, a plurality of conversion rates between the base currency of the webpage and a plurality of currencies;
transmit, to a client computer system, a webpage and a currency conversion plug-in, wherein:
the currency conversion plug-in is configured to convert prices displayed on the webpage from the base currency of the webpage to a currency of a purchaser; and
a merchant operates the computer system;
the purchaser operates the client computer system; and
the plurality of currencies comprises currency of the purchaser;
receive, from the client computer system, purchase information and payment information, wherein the payment information is used to conduct the payment in the purchaser's currency; and
authorize the purchase in the purchaser's currency.

18. The system of claim 17, wherein the purchase information comprises a product code.

19. The system of claim 17, wherein the transaction is authorized and settled in the purchaser's currency.

20. The system of claim 19, wherein a value of the purchaser's currency used to settle the online payment is approximately equal to a value of the base currency necessary to settle the online payment.
